(19) United States
(12) Patent Application Publication
(10) Pub. No.: US 2015/0226828 A1
(43) Pub. Date: Aug. 13, 2015

(54) SYSTEMS AND METHODS FOR TRACKING AND TAGGING OBJECTS WITHIN A BROADCAST

(71) Applicant: Fox Sports Productions, Inc., Los Angeles, CA (US)

(72) Inventors: Michael Davies, Marina Del Ray, CA (US); Zachary Fields, Woodland Hills, CA (US); David Eric Shanks, Los Angeles, CA (US); Gerald Steinberg, Marina Del Rey, CA (US)

(21) Appl. No.: 14/424,632

(22) PCT Filed: Aug. 30, 2013
(86) PCT No.: PCT/US13/57450

§ 371 Date: Feb. 27, 2015

Related U.S. Application Data
(60) Provisional application No. 61/695,977, filed on Aug. 31, 2012.

(51) Int. Cl. G01S 3/786; G06T 11/00; H04N 21/81; H04N 21/488; H04N 21/854

(52) U.S. Cl. CPC G01S 3/7864; H04N 21/488; H04N 21/854; H04N 21/8146; G06T 11/00

(57) ABSTRACT

The present disclosure presents an improved system and method for tracking and tagging objects of interest in a broadcast.

### BACKGROUND

The present disclosure relates to systems and methods for tracking and tagging of objects within a broadcast. In exemplary embodiments, the present disclosure relates to improved methods for systematically analyzing a broadcast, specifically tracking of players on a sports field and selectively tagging those players during a broadcast.

While general identification of objects within a broadcast has been known, there is room in the field for improvement, for example by selectively tracking one or more objects within a broadcast along tagging that object and including additional information with regard to that object, as is described herein.

Accordingly, the following disclosure describes tracking of one or of a plurality of objects, e.g., one or multiple football players on a field during broadcast, along with broadcast animated tracking and provision of information, e.g., statistics, of those one or more players.

### SUMMARY

The above described presents an improved system and method for tracking and tagging objects of interest in a broadcast. While the following is described in reference to an athletic performer, the present disclosure is not so limited. Indeed, the present disclosure relates more generally to tracking and tagging of any kind of objects.

In exemplary embodiments, one or more objects within a broadcast are tracked and tagged with information, e.g., information relevant to a play or to performance of an athlete on a field of play.

An automated system might track one, a plurality or all players on a field, such that an operator may easily select one or more players during a broadcast. Such selection may permit an operator to supply, or may present one or more pre-selected options, e.g., statistics in general or relevant to a given play (e.g., number of successful completions for a receiver in general or given a particular circumstance), statistics relevant to a given player.

Other exemplary embodiments provide for video overlay of such statistics during (or after) a broadcast of information, e.g., statistics, name, etc., relevant to a player. Such video may be static or dynamic, fully or partially displayed (e.g., when a player moves off the broadcasted display), solid, faded, phased in or out, etc.

Exemplary embodiments also provide for tracking of one or plural players across a field, wherein the video information perfectly or imperfectly follows a player during play motion. Imperfect follow may be desired in certain circumstances, e.g., to enhance the perceived motion of the player, e.g., during breaking of a tackle, a particular cut or breakout move. Further, rise or fade of a statistic graphic can be strategically orchestrated to prevent distraction from a play but also to provide unobtrusive secondary information to a viewer of broadcast content.

The above discussed and other features and advantages of the present invention will be appreciated and understood by those skilled in the art from the following detailed description and drawings.

### BRIEF DESCRIPTION OF THE DRAWINGS

Referring now to the drawings, wherein like elements are numbered alike in the following FIGURES:

FIG. 1 is an illustration of an exemplary tracked athlete on a field of play;

FIG. 2 is another illustration of an exemplary tracked athlete on a field of play;

FIG. 3 is an illustration of an exemplary tracked athlete with faded statistics;

FIG. 4 is an illustration of an exemplary tracked athlete with additional player statistics;

FIG. 5 is another illustration of an exemplary tracked athlete with faded statistics;

FIG. 6 is an illustration of plural exemplary tracked athletes;

FIG. 7 is an illustration of exemplary tracked athletes with partially displayed statistics;

FIG. 8 is an illustration of an exemplary tracked athlete with game statistics;

FIG. 9 is an illustration of an exemplary tracked athlete with disappearing statistics;

FIG. 10 is an illustration of an exemplary replay functions;

FIG. 11 is an illustration of exemplary graphic functions;

FIG. 12 is an illustration of an exemplary operator's user interface;

FIG. 13 is an illustration of an exemplary camera and setup;

FIG. 14 is an illustration of an exemplary camera and image capture;

FIG. 15 is an exemplary system plan in accordance with embodiments of the present disclosure;

FIG. 16 is another exemplary system plan in accordance with embodiments of the present disclosure;

FIG. 17 is an exemplary workstation layout in accordance with embodiments of the present disclosure;

FIG. 18 is another exemplary workstation layout in accordance with embodiments of the present disclosure;

FIG. 19 is an exemplary graphical user interface of a 4K captured image with a 720 p selectable extraction window;

FIG. 20 illustrates an exemplary embodiment showing relative extractions.

FIG. 21 is an exemplary first system for capturing and transporting a 4K image to an offsite processor and graphical user interface; and

FIG. 22 is an exemplary second system for capturing and processing a 4K image onsite, followed by transport of a high definition image offsite.

### DETAILED DESCRIPTION

As was noted above, the present disclosure relates to an improved system and method for tracking and tagging objects of interest in a broadcast. While the following is described in reference to an athletic performer, the present disclosure is not so limited. Indeed, the present disclosure relates more generally to tracking and tagging of any kind of objects.

In exemplary embodiments, one or more objects within a broadcast are tracked and tagged with information, e.g., information relevant to a play or to performance of an athlete on a field of play.

An automated system might track one, a plurality or all players on a field, such that an operator may easily select one or more players during a broadcast. Such selection may permit an operator to supply, or may present one or more pre-selected options, e.g., statistics in general or relevant to a given play (e.g., number of successful completions for a receiver in general or given a particular circumstance), statistics relevant to a given player.

Other exemplary embodiments provide for video overlay of such statistics during (or after) a broadcast of information, e.g., statistics, name, etc., relevant to a player. Such video may be static or dynamic, fully or partially displayed (e.g., when a player moves off the broadcasted display), solid, faded, phased in or out, etc.

It should be noted that partial display of information relates to the idea that tagging need not be specifically related to a displayed broadcast image, but rather to the recorded images, whether selectively displayed or not during a broadcast. Tracking and tagging can be larger than the displayed portion during broadcast, and can wander in and out of the broadcast image itself, as desired or not. Further, delayed tracking, or delayed broadcast is contemplated, to allow an operator or an animator to tag a player of interest, if real time is not sufficient for either or any party. Such tagging may be via linked terminals or via wireless devices, such as tablets, which are either generally associated with the network or specifically identified to the network (e.g., assigned to a specific animator, operator, etc.).

Exemplary embodiments also provide for tracking of one or plural players across a field, wherein the video information perfectly or imperfectly follows a player during play motion. Imperfect follow may be desired in certain circumstances, e.g., to enhance the perceived motion of the player, e.g., during breaking of a tackle, a particular cut or breakout move. Further, rise or fade of a statistic graphic can be strategically orchestrated to prevent distraction from a play but also to provide unobtrusive secondary information to a viewer of broadcast content. The various attached FIGURES illustrate the point, e.g., partial entry of Andrew Hawkins (this is a simulated overlay on an established game) for a kickoff return.

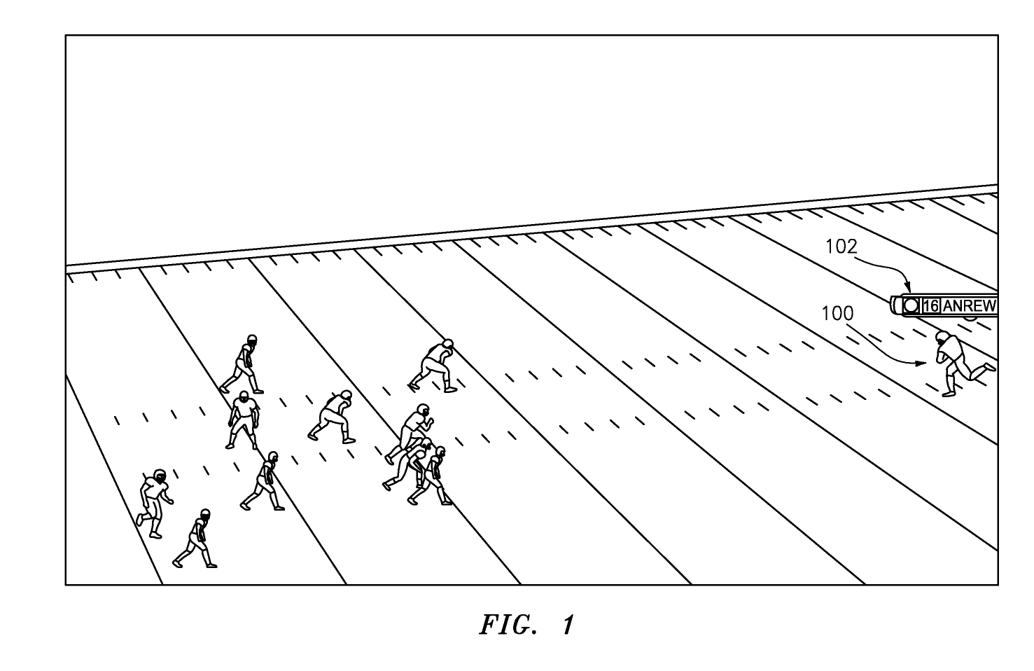

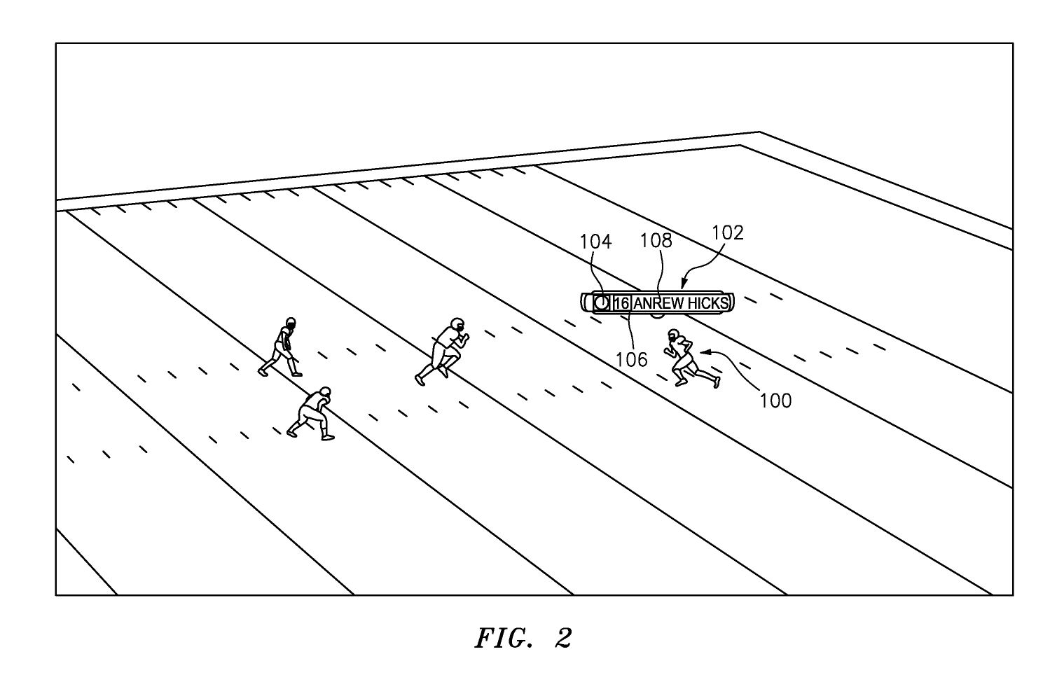

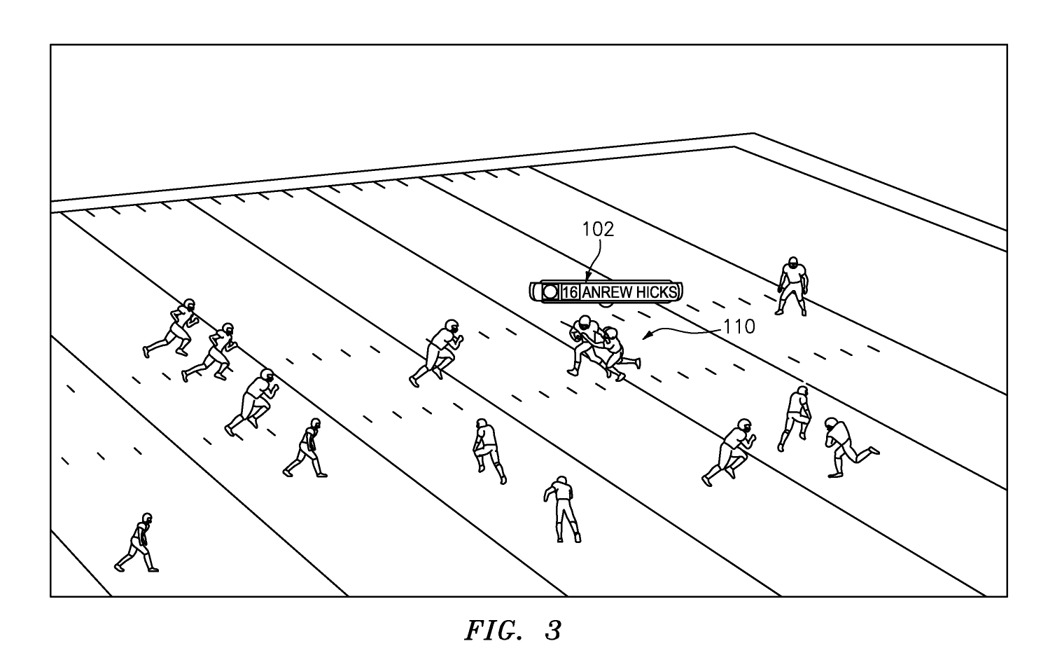

For example, FIG. 1 illustrates Andrew Hawkins, shown generally at 100, entering a right hand frame of a punt return. In this sequence, Hawkins is tracked, but the overlay, shown generally at 102, optionally only displays part of his information (since he is only just within the frame). As he moves into the frame, e.g. at FIG. 2, his information 102 is completely illustrated, in this case team 104, number 106 and name 108. At FIG. 3, we see a tackle, shown generally at 110, between ten and fifteen yards, and optionally, his information fades from the broadcast.

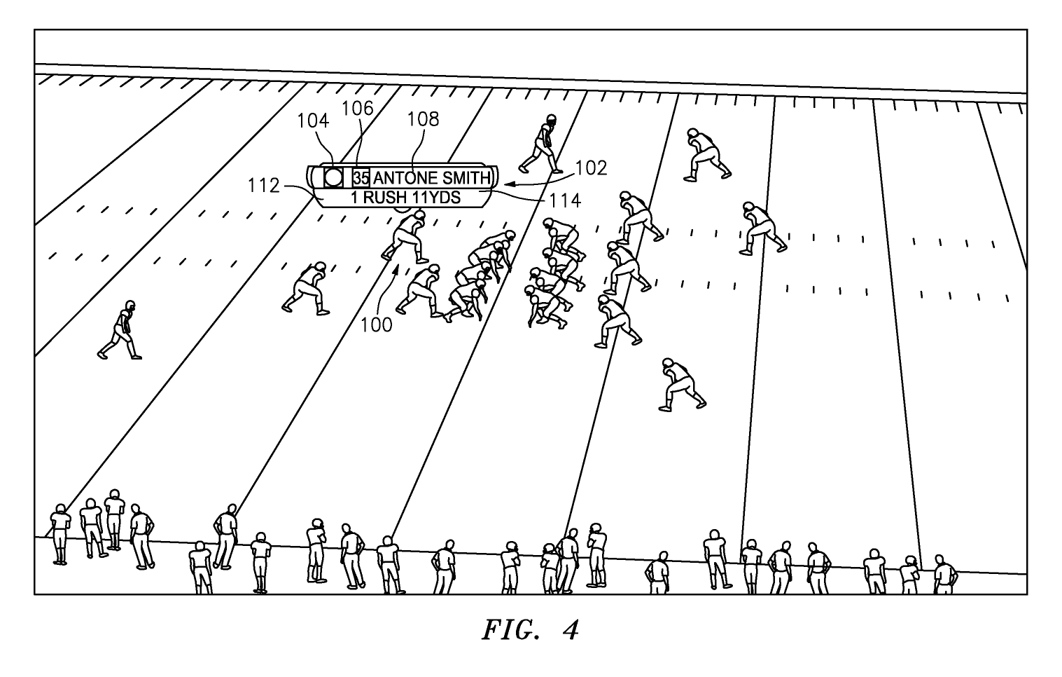

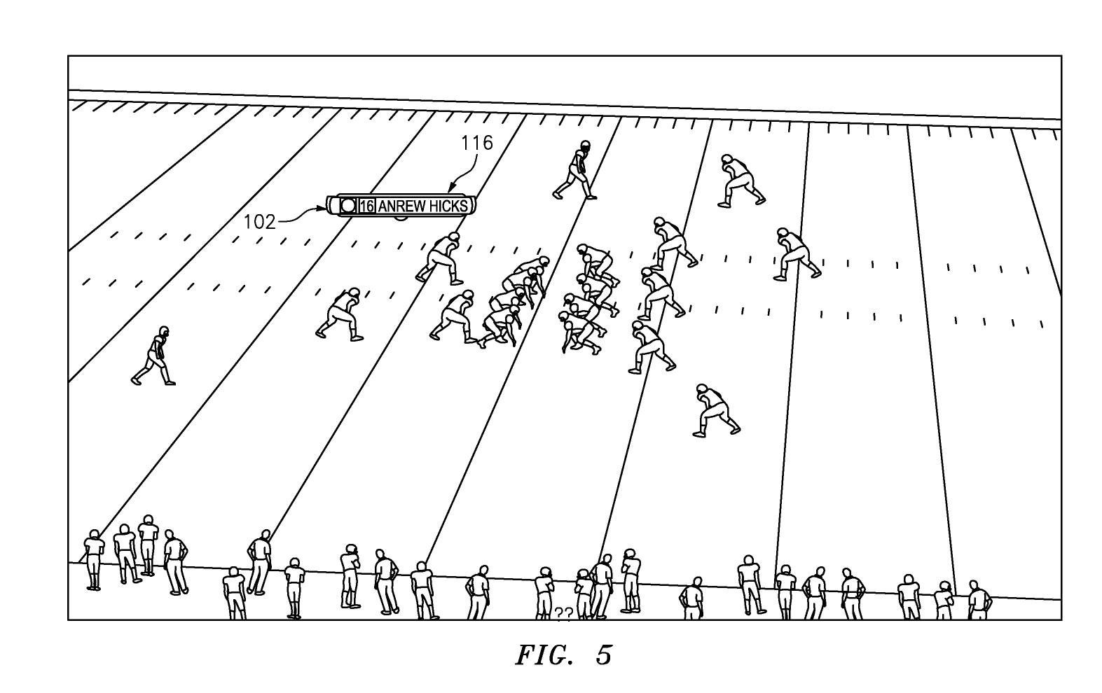

A similar example is proved at FIGS. 4-5, wherein Antone Smith 100 is shown in position on a first and ten play, without significant play (other than spreading of defense), with fully displayed information 102, in this case team 104, number 106, name 108, rushing 112 and yardage 114, followed by fade of the animation immediately prior to the action, shown generally at 116 in FIG. 5.

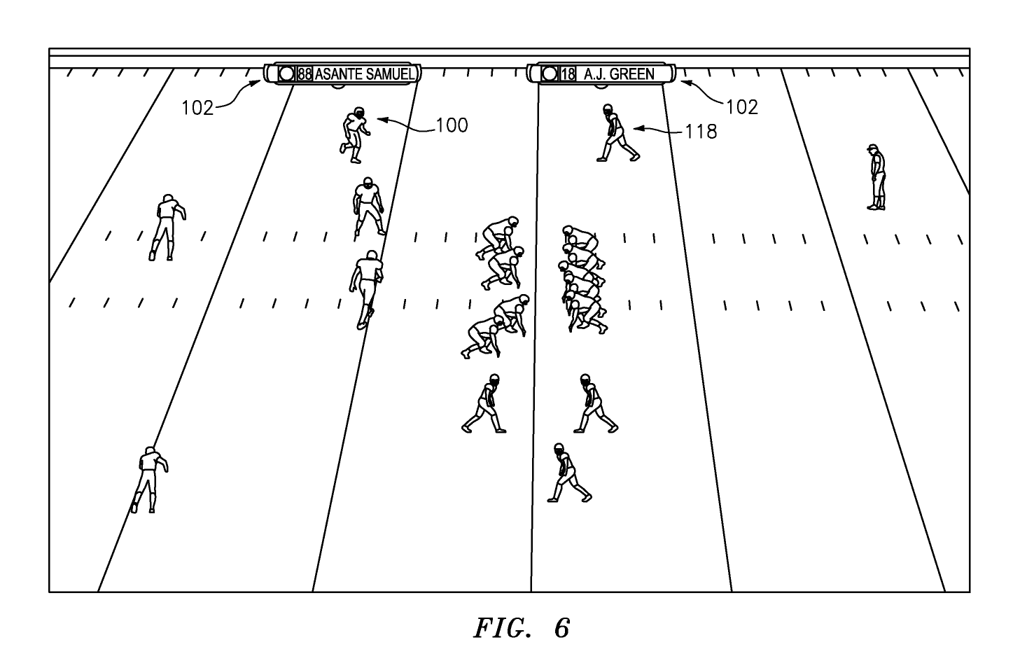

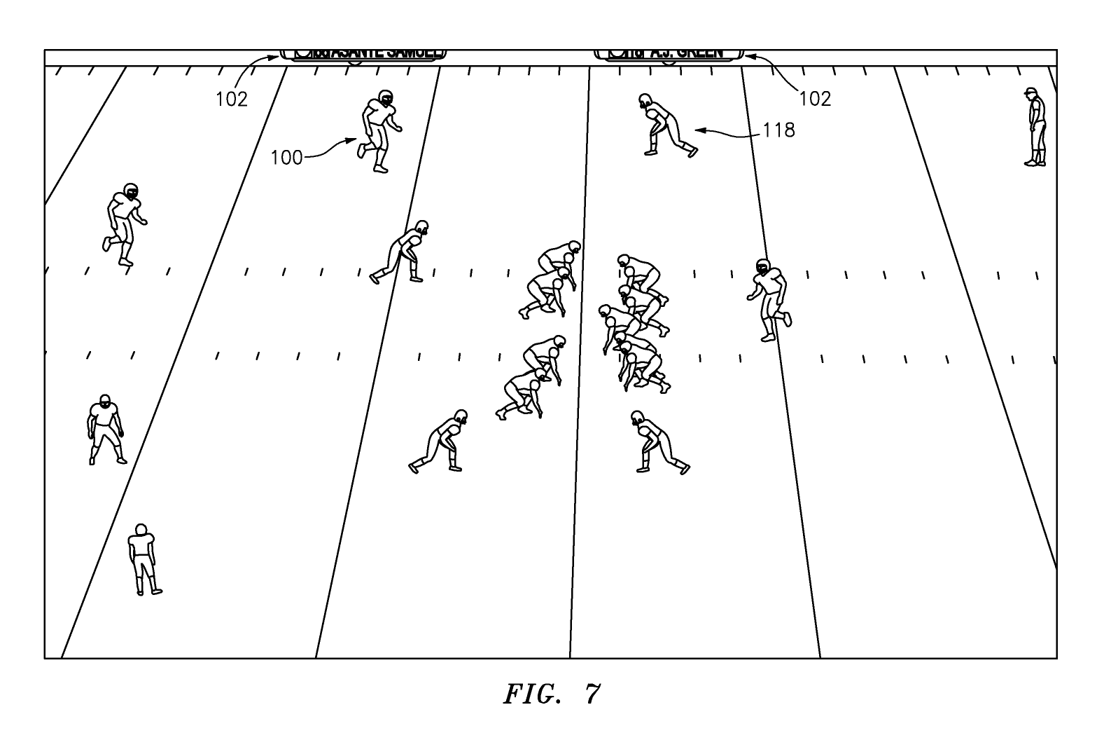

FIGS. 6-7 illustrate plural tracked players (in this case two), shown generally at 100 and 118, respectively, though the number of possible tracked objects (balls, lines, field marks, coaches, other marks)/players should not be limited in the present disclosure. In this case, Asante Samuel 100 and A. J. Green 118 face off, but in FIG. 7, as the broadcast image shifts, the tagged information 102 partially moves off-screen for the broadcast.

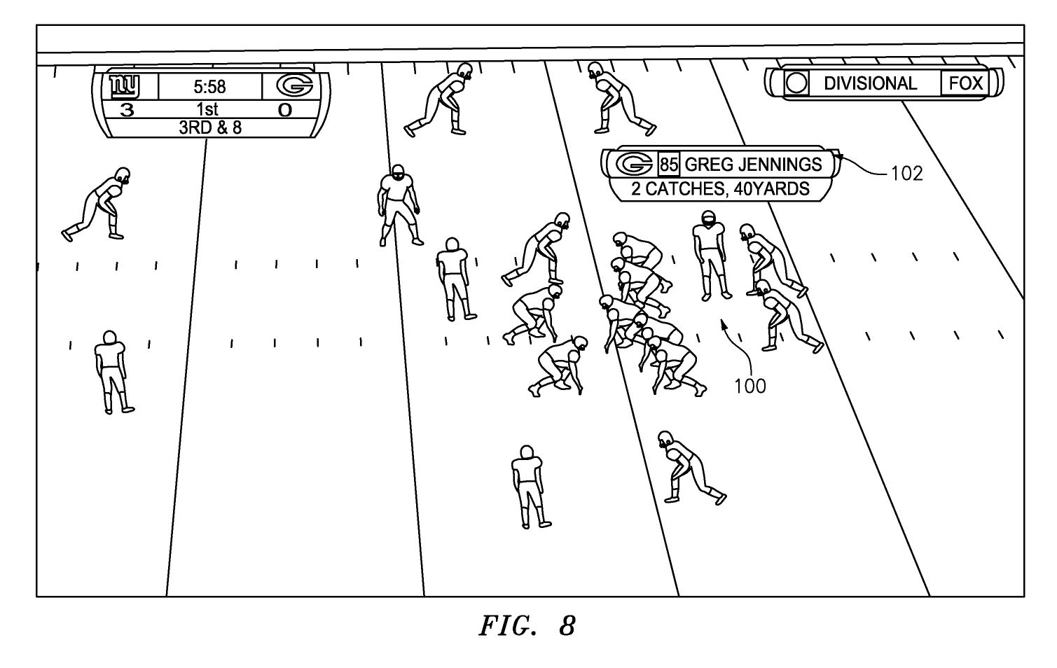

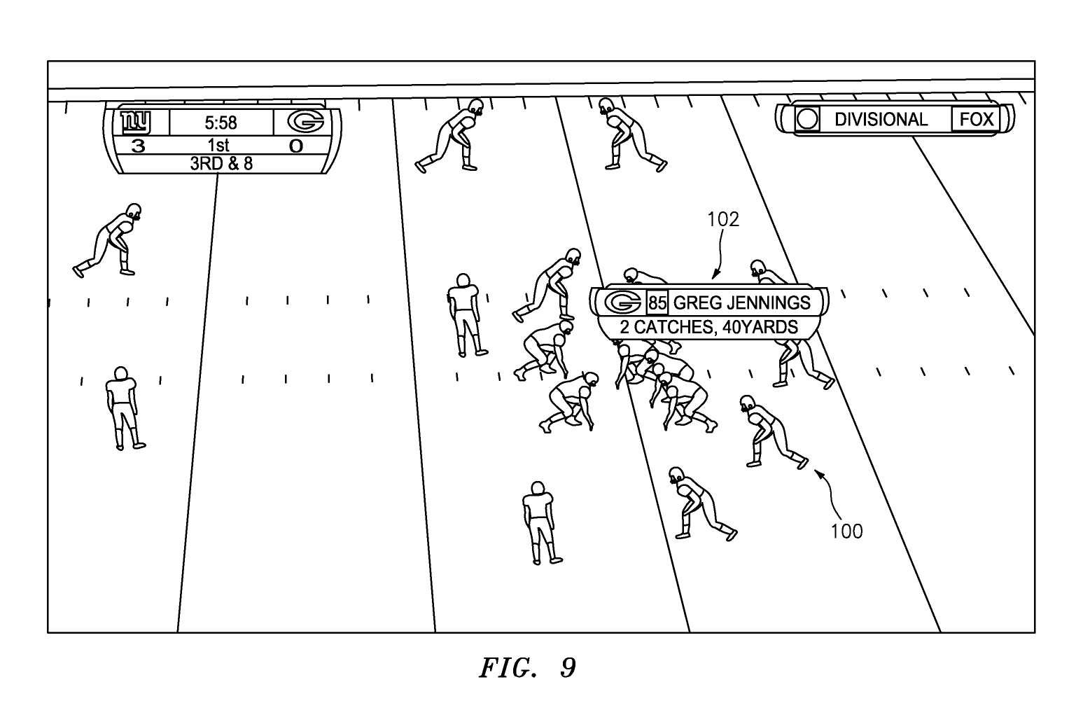

FIGS. 8 and 9 provide another example of tagging, wherein Greg Jennings 100 is clearly tagged at 102 in FIG. 8 during a play shift, followed by FIG. 9 at the snap with the tagged information 102 fading so as not to distract from the play.

The presently described systems and methods advantageously provide tracking of objects (e.g., players) of any number. One embodiment provides tracking of five players on each side of an event (e.g., basketball). Others provide tracking of the five for each, plus the “sixth man,” i.e., certain or all of the fans, or commentator, (e.g., Dick Vitale), such that interesting events outside the actual field can be either automatically or manually recognized as potentially valuable to broadcast. An automatic identification can be related to prior recognized statistics or importance (e.g., game, series, etc. statistics, social media relevance, celebrity status, etc.).

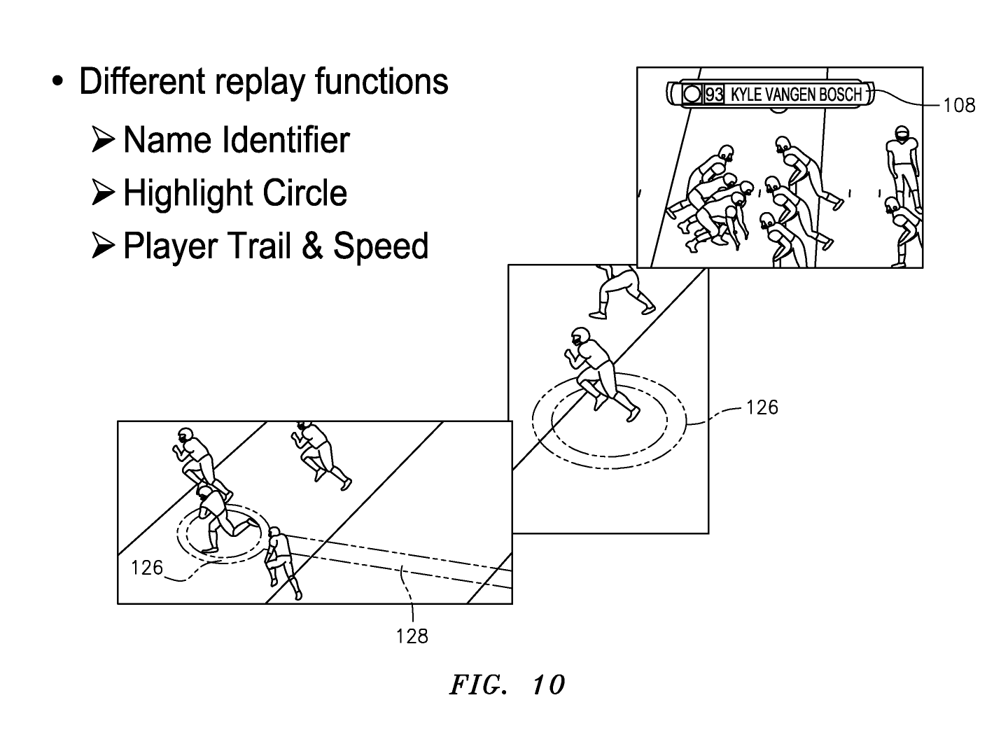

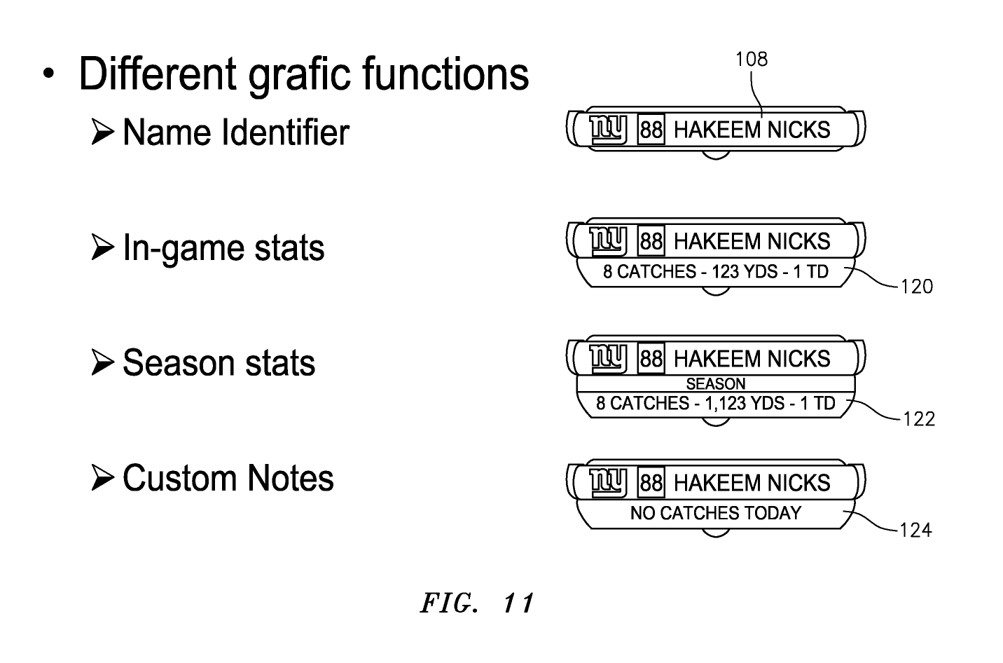

Advantageously, exemplary present systems and methods provide for plural replay functions, e.g., name identifier 108, highlight circle 126, player trail and speed 128, as is illustrated in FIG. 10. Further, various graphic functions may be employed, as in FIG. 11 or otherwise, including, e.g., name identifier 108, in-game stats 120, season stats 122, player or coach comments and custom notes 124.

Exemplary embodiments also provide for improved edit software, including, without limitation: “fly” between cameras, virtual camera angles, stop motion action, enhanced telestration and visual analysis, etc. The present disclosure may also be used for pre-produced packages, live-in-studio, and large scale events.

Further, it should not be ignored that various implementations, including those described below, may use touchscreens as interfacing for controlling any of the various described functions.

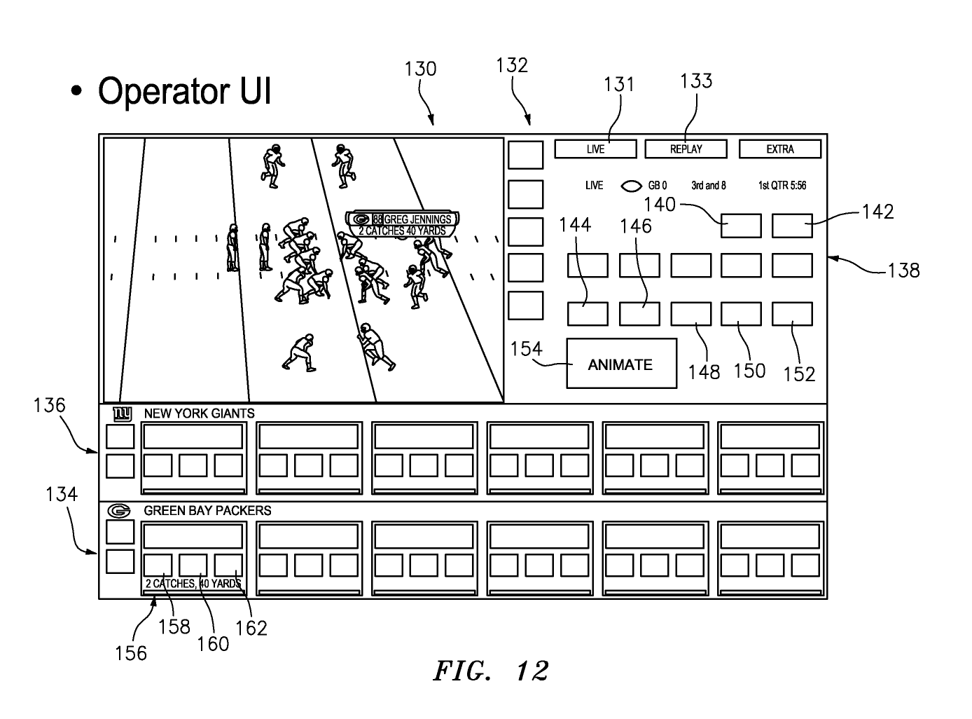

FIG. 12 illustrates an exemplary user interface (UI), shown generally at 130, which enables selective view 131, capture, replay 133, etc. of various cameras, shown generally as selections 132, on an event. As can be seen from the figure, this exemplary embodiment is tracking ten players (offense 134 vs. defense 136), and allows for one or more selections via an operator. In exemplary embodiments, one or more monitors may be provided to the operator in order to further facilitate tracking of plural athletes. Also, as can be seen from the figure, the UI contemplates favorites 138, auto 140 and manual 142 modes, highlight 144, swap 146, audio 148, disk 150 and extra 152 modes, as well as animate commands 154. With reference to the tracked players, but without limitation, this particular embodiment facilitates player (one or more) selection of statistics, shown generally at 156, game 158, season 160 or text 162 related.

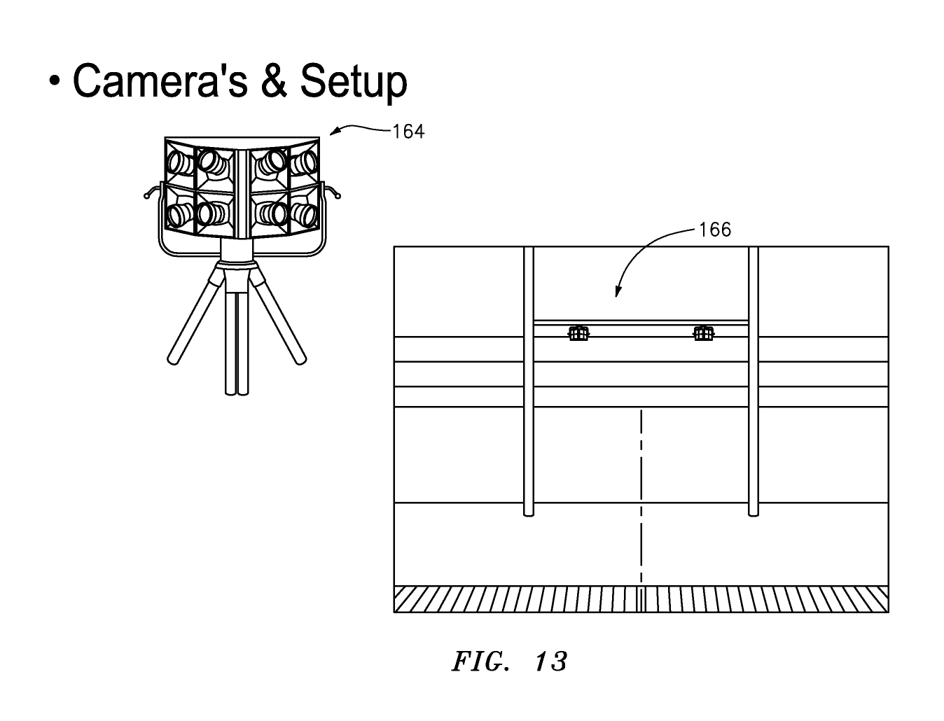

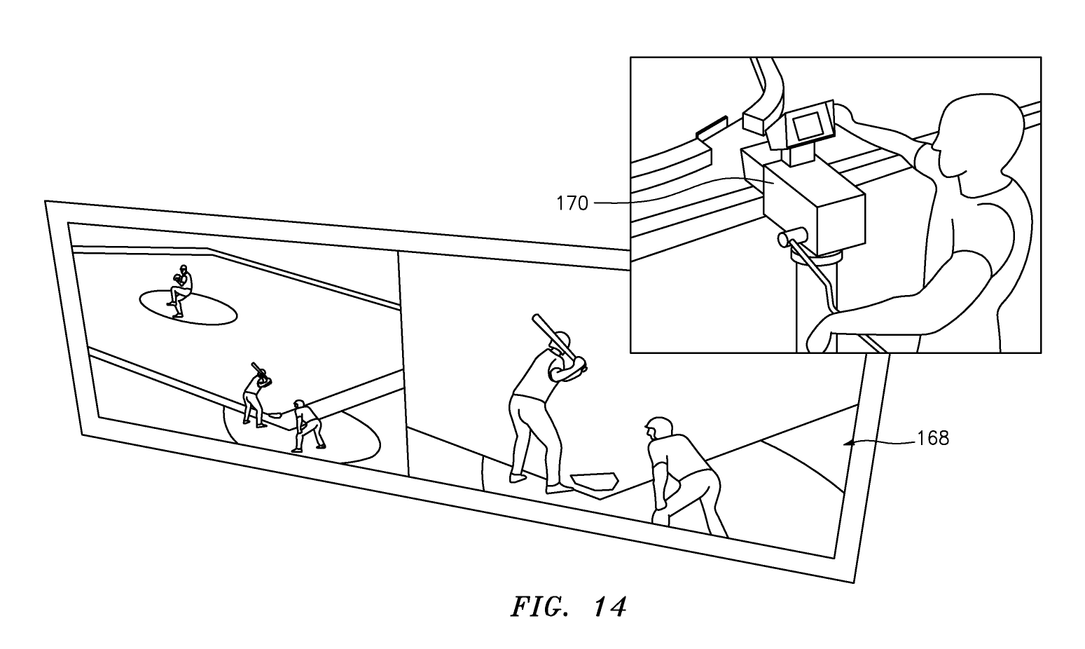

FIG. 13 illustrates an exemplary camera setup, showing a camera array generally at 164, as well as a camera hang setup (e.g., 21 feet on the field center line), shown generally at 166, for football. FIG. 14 shows captured image 168 from cameras 170.

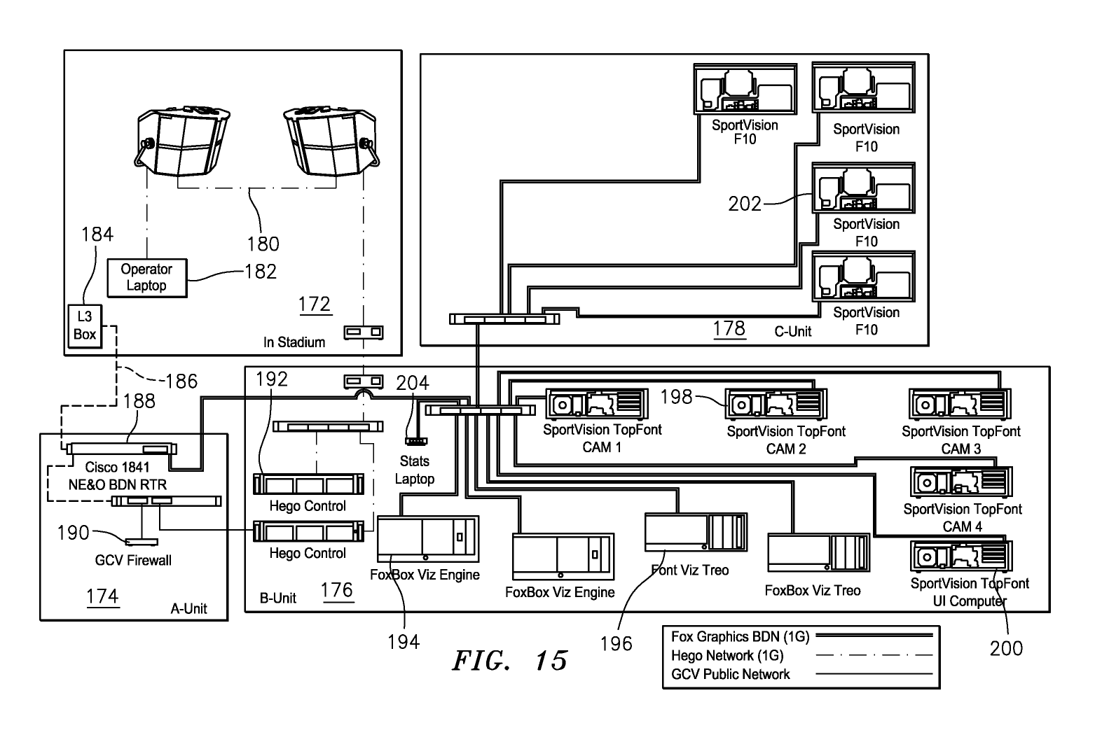

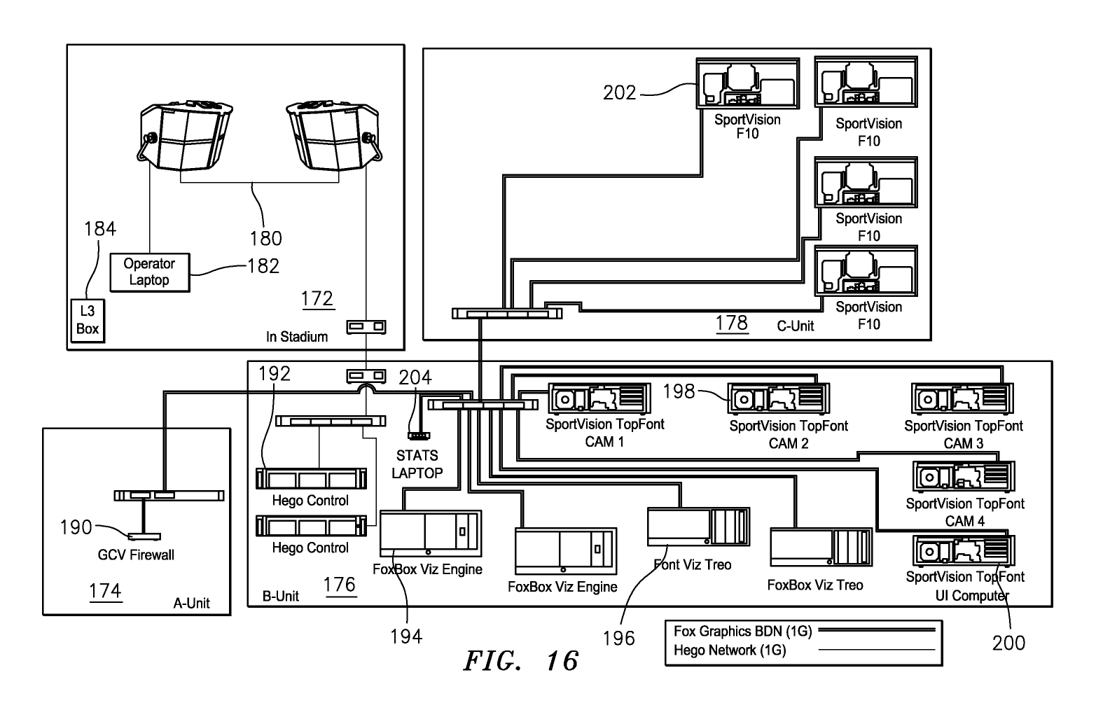

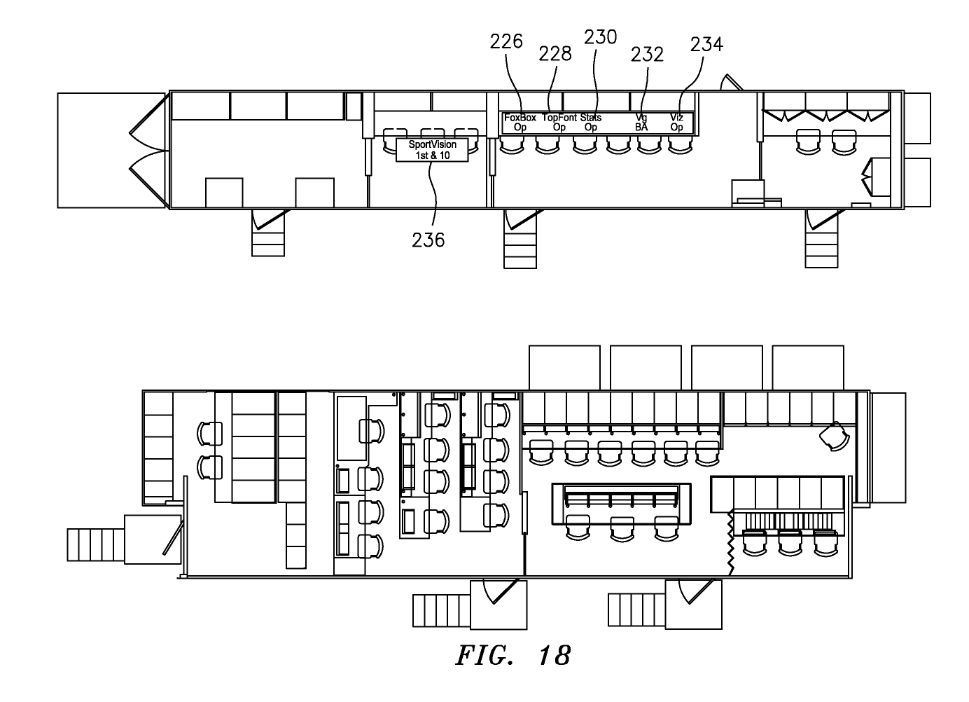

FIGS. 15-18 illustrate an exemplary control setup for such a system, including in-stadium components 172, A-Unit components 174, B-Unit components 176 and C-Unit components 178. FIGS. 15 and 16 illustrate camera arrays 180 and an operator laptop 182 and connection 186 via an L3 Box 184 to a router 188 and firewall 190 in the A-Unit. B-Unit includes control engines 192, Viz engines 194, Viz Treos 196 and top font cam processing systems 198 alongside a UI computer 200. C-Unit shows SportVision systems 202. A stats laptop 204 is also illustrated in the B-Unit.

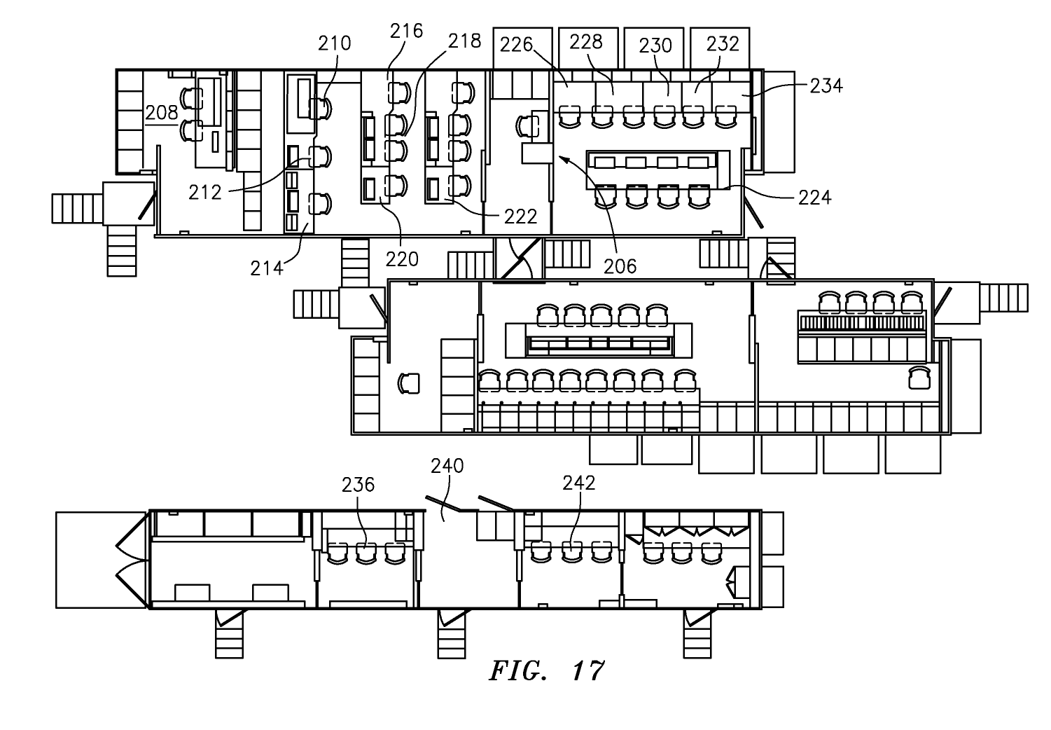

FIG. 17 shows the graphics racks 206 surrounded by various studio stations, including audio submix 208, TD 210, Director 212, Producer 214, 8 Second Guy 216, AD 218, Exec 220, Tech manager 222, stats 224, FoxBox Op 226, Topfont operator 228, Stats Op 230, Viz BA 232, Viz Op 234, along with SportVision 1&10 236 in an edit room 238, a 4K operator 240 and a Game Edit 242.

In an exemplary embodiment, Network Connectivity vs. Systems Closed Network include Cat5 to camera, Fiber to Camera or Fiber to truck, with an unobstructed view of field, a monitor showing previews of all renders, a program monitor, and a PL station with Iso to TopFont Operator (e.g., with a 2 Channel beltpack or a KP Panel). Two or more single mode fibers may be used for the monitoring feed, potentially a 3^{rd} to put on a RVON KP panel.

In exemplary embodiments, optical tracking tracks moving objects on a field of play. This includes any type of tracking, be it image recognition, motion sensitive indication of possible tracking, etc.

An exemplary system is proposed below as Example 1:

### Example 1

### Scope

This procedure applies to \ “A” Crew, but could be applied in general to any originated broadcast for which TracAB is desired.

This will apply to the operations on site. It is assumed that all the under the hood workings between affiliates are working.

### Example 1

### Roles

TracAB Operator—Primarily responsible for performing field alignment of TracAB cameras and tagging players during the event. Communicates with TopFont Operator with regards to the status of the objects currently being tracked. Located in the stadium in a location that allows for an unobstructed view of the field. Works with department with regards to obtaining available fiber in the building. Works with Sports Audio department with regards to setting up Intercom at operating position. Troubleshoot TracAB system as needed. Relays to Tech Manager any issues with setup or operation of equipment in a timely fashion.

TopFont Operator—Primarily responsible for inserting TopFonts during broadcast using company provided touchscreen interface. Communicates with Producer, Director, Stats, Graphics BA in identifying what graphics are needed when. Also works with Tape Room for enhancements on replays. Communicates with TracAB Operator regarding key players that need to be tagged for each series. Troubleshoot TopFont system as needed. Relays any issues with setup or operation of equipment to Tech Manager in a timely fashion.

First and 10 Operator—Builds provided tripods and panheads for 4 camera locations. Calibrates those panheads and cameras for use for both the First and 10 system and the TopFont System. Verifies connectivity to the TopFont System. Operates First and 10 system during game. Troubleshoots First and 10 system, Pan, Tilt, Zoom data as needed. Relays any issues with setup or operation of equipment to Tech Manager, Techincal Director and EIC in a timely fashion.

EVS Operators—Verify that all machines are setup to record and playback RP-188 Timecode properly. Performs test with Technical Director and TopFont Operator on set day to verify. Relays any issues with operation of Equipment to Tech Manager and EIC in a timely fashion.

Mobile Unit Engineers—Works to integrate systems into the broadcast both from a video standpoint and a networking standpoint. Verify all signals are present and acceptable. Assist TracAB Operator, TopFont Operator, First and 10 Operator with troubleshooting as able.

### Example 1

### Definitions and Acronyms

TracAB—Optical tracking system consisting of 2 camera arrays, a processing computer and a tracking computer. In this instance, it will be used to provide positioning information of objects (players) in a 3D space for the use of inserting informational graphics. These devices will be networked together using gigabit Ethernet switches on their own closed network. The processing computer will be connected via a second NIC to the graphics network.

TopFont—TopFonts to be delivered as a composited HD-SDI version of one of 4 cameras through 4 separate renderers. The system consists of a User Interface computer with a touch screen and 4 rendering computers. Each of these 5 computers will be networked together using gigabit Ethernet switches to the graphics network.

First and 10—The system which currently inserts the down and distance (“yellow line”).

Media Converter—An optical-electrical converter. In this case, it is used for the purpose of converting Ethernet to fiber in the stadium, and then fiber back to Ethernet at the truck location.

BDN—Fox's Broadcast Data Network used as the graphics network on the NFL Games.

Fiber Optic Cable—In this document any Fiber optic cable will be referring to single mode fiber unless otherwise specified.

GBE Switch—A managed switch capable of transmissions of 1 gbps between ports.

### Example 1

### Procedural Steps

### Example 1

### Initial Integration

Identify space for 4 RU of processing computers. Install Processing computers in racks. Install GBE switch for closed network. Connect NIC 1 from each processing computer to the GBE Switch for closed network. Set IP Address information on NIC 2 of systems provided processing computers using IP information for the graphics network.

HD-SDI input and output need to be connected to each renderer and made available in production switcher and routing switcher. Preview output of each TopFont Render will be provided by a scan-converted output. This needs to be made available in the routing switcher.

First and 10 System is installed as normal. The First and 10 system is not included in the 20 RU count.

Set IP address information on each of the provided computers (rendering engines, user interface computers) using IP information for the graphics network. (Hopefully the IP Address information can be provided before the machines ship, but this may not be the case).

Connect each of the provided computers to the gigabit Ethernet switch that contains the graphics network. Connect Top Font Operator User Interface position. Turn on all computers and verify network connectivity between all devices in the truck.

### Example 1

### Weekly TracAB Setup

TracAB mounting locations are verified with stadium personnel and Tech Manager. TracAB cameras unloaded out of C-Unit and transported into Stadium. TracAB camera arrays are mounted.

Take Reference picture from alongside each TracAB camera array. Power is needed at each TracAB array. Ethernet Cable is used to connect from one TracAB array to the other.

If the distance is too great for GBE signals to pass, or it is not physically possible to run a CAT-5 Cable between the cameras, a set of GBE Capable media converters may be used between the cameras. One TracAB array is connected to the closed Hego Systems network in the truck via a Gigabit capable media converter. The other TracAB array is connected to the TracAB operators laptop by Ethernet cable. If the distance is too great for GBE signals to pass, or it is not physically possible to run a CAT-5 Cable between the camera and the operating position, a set of GBE Capable media converters may be used between the camera and the operating position or the truck and the operating position.

TracAB Operator sets up operating position consisting of video monitor, laptop computer and intercom. TracAB Operator calibrates arrays and verifies everything with regards to the TracAB system is functioning properly. TracAB Operator reports to Tech Manager when system is fully operational.

An exemplary user Interface (UI) that may be used to tag the players is described immediately below:

Exemplary cameras track the players and send the information to a computer. An operator on the computer either: manually tags the players; views an automatic tag; or confirms an automatic tag. This data is passed onto a computer where an operator can now render the appropriate graphic to air.

Optical tracking tracks moving objects on a field of play, which can be a relatively manual process of assigning the proper player to the right moving object. However, additional exemplary embodiments may work as follows:

Exemplary processes and workflow allow tagging of players quickly. This can include moving the physical tagging process to the truck, instead of at stands or by the cameras. The present disclosure also suggests various strategies to tag players using game cameras, e.g., routing appropriate game cameras to the operator for more efficient tagging.

The present disclosure also describes a wholly different way to track players, such as a method of having the graphics operator be able to tag players from his user interface, by potentially using his touchscreen.

The present disclosure also contemplates a reverse tagging method, to relate a player on the screen on the field and ask the tagging computer which player is closest to the place on the field which was touched on the other computer. It may then tag the appropriate player with the object that is closest on the field.

Further, this technology may be used for advantage with greater than HD technology, particularly in area of interest highlight.

An exemplary process is so:

Start with full raster greater than HD video, e.g., 4 k video.

A graphical box or cursor, representing the area to which we are interested may appear.

The view then zooms to fill the box.

Exemplary embodiments of greater than HD systems and methods follow: a first image or video is captured at a first resolution, which resolution is greater than high definition and higher than a predetermined broadcast display resolution. A desired portion of the first image or video is then displayed at a second, lower resolution, which resolution is less than and closer to the predetermined broadcast display resolution. Accordingly, a selected portion of the captured image may be displayed at or near the predetermined broadcast display resolution (i.e., minimizing or eliminating loss of image detail relative to the predetermined broadcast display resolution).

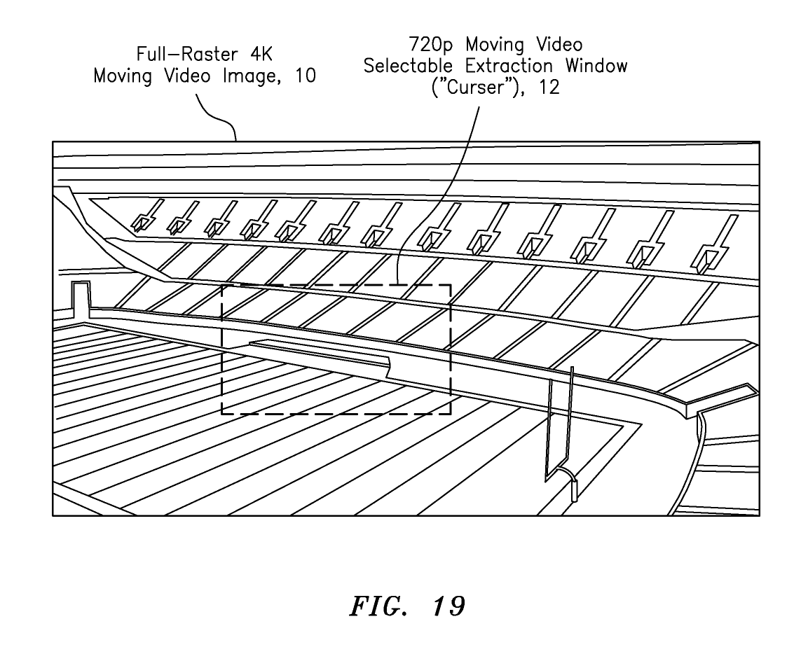

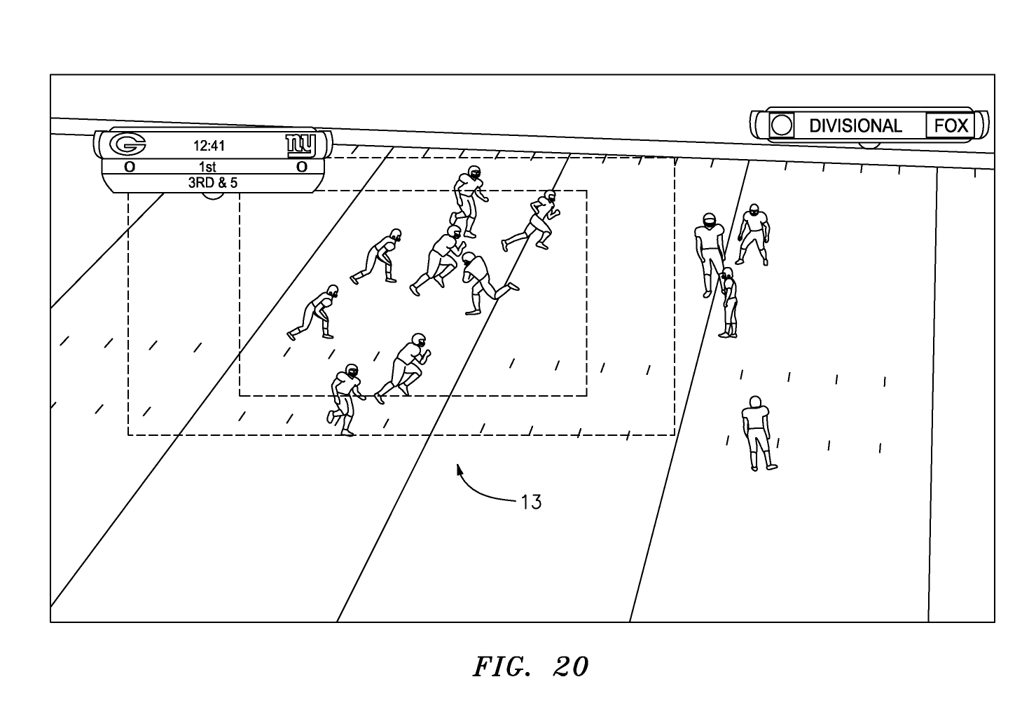

An example of this is illustrated at FIG. 19, which shows a screenshot of a full-raster 4K moving video image 10. A portion of the 4K image, illustrated as a 720 p moving video selectable extraction window 12, is then selected for presentation. Thus, native image capture occurs at a greater than high definition resolution, and portions of that greater than high definition image are selected for presentation via the 720 p extraction window. While, FIG. 17 specifically illustrates 4K capture and a 720 p extraction window, it should be recognized that both or either of the captured image and extraction window may be provided at or sized to other resolutions. FIG. 20 shows a similar view of relative extractions, provided generally at 13.

Also, while one extraction window is illustrated in FIG. 19, the present disclosure contemplates simultaneous multiple extraction windows that may be applied to the same captured image.

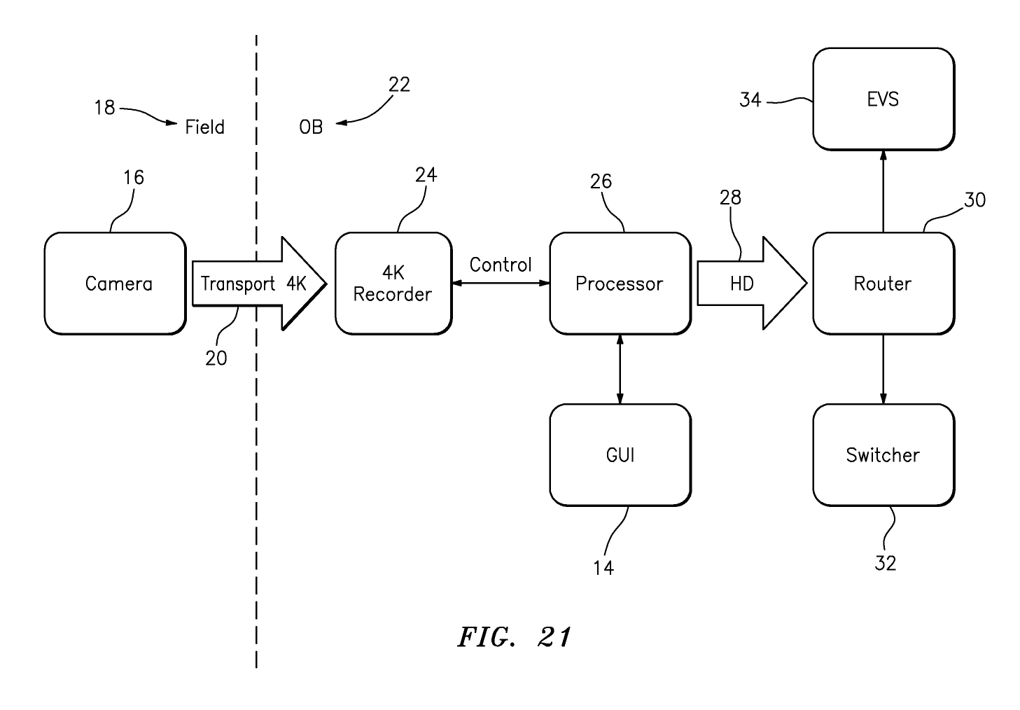

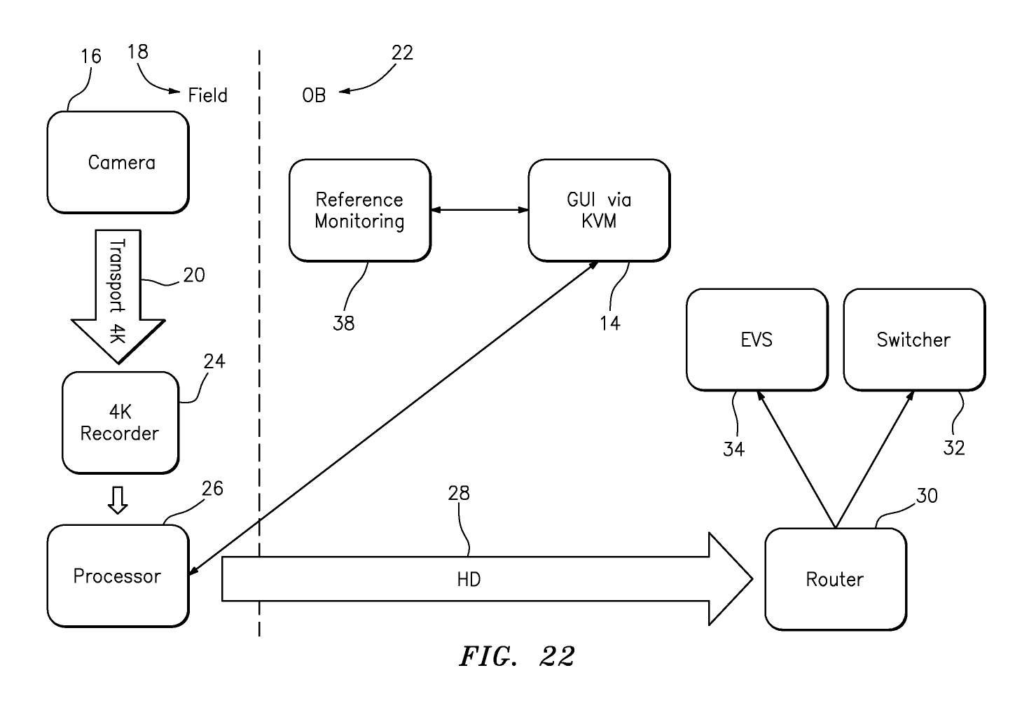

In further exemplary embodiments, the selectable extraction window (12 in FIG. 19) is provided at a graphical user interface (“GUI”) (14 in FIGS. 21 and 22) that is configured to allow an operator to navigate within a captured image and select portions of the captured image for presentation. In exemplary embodiments, the extraction window is configured to allow the operator to adjust the size and position of the extraction window. In other exemplary embodiments, the extraction window is configured to track or scan across moving images, e.g., to follow a play or subject of interest during a sporting event. In other exemplary embodiments, plural operators may extract from the same images via the same or via plural GUIs.

Referring now to FIGS. 21 and 22, processing of the captured images may occur either offsite (FIG. 21) or onsite (FIG. 22). Referring to FIG. 21, an exemplary system is illustrated wherein a camera 16 captures 4K images onsite, e.g., at a field (shown generally at 18) for a sporting event. A transport mechanism 20, e.g. a fiber capable of transporting a full bandwidth 4K video, transports the captured images to an operations base (“OB”) (shown generally at 22), e.g., a production truck away from the field 18.

An image recorder 24 records the captured images, e.g., as a data stream on a server, and is configured to allow an operator to go back in time relative to the recording and examine selected portions of the captured image as described above. Such control is provided to an operator via the GUI 14 through a processor 26 interfacing with the GUI 14 and recorder 24. In exemplary embodiments, the recorder, processor and GUI are configured to allow the operator to go back instantaneously or near-instantaneously to select portions of the recorded image for presentation.

For example, with regard to FIG. 21, an operator in a truck would use a GUI to navigate the full raster 4K image and maneuver the selective 16:9 extraction window, in a manner similar to a cursor, to select an area of interest. In exemplary embodiments, the GUI is configured such that the extraction window may select an area of interest in one or both of live and recorded video. Also, as has been noted above, the present disclosure contemplates sizing and zooming capabilities for the extraction window. In other exemplary embodiments, the system is configured to mark keyframes and establish mapping for desired moves, e.g., pans and zooms, among others, around the image.

Referring again to FIG. 22, in exemplary embodiments, the output 28 of the system (e.g., a 720 p/59.94 output relative to a 4K capture) is provided to a router 30 that allows the output to be taken live to a switcher 32 or to be ingested at a server 34 (“EVS”) for later playout. Also, in exemplary embodiments, a resulting image can be slowed down for replay or rendered as a still image, if desired, either at the server 34 or at the operator's position (via processor 26).

FIG. 22 provides an alternate exemplary embodiment, wherein capture, transport and recording of the native image (in this example 4K images) occurs onsite, e.g., at the field 18 of a sporting event). An onsite processor 26 provides or interfaces with an operator GUI 14 in an operations base 22 (e.g., a truck, though the GUI could be accessed from any convenient location) and provides a reference video 38 of the image to allow the operator to navigate the image via the extraction window. The output 28 is then transported from the field to an offsite router 30.

In another embodiment, at least one GUI is accessed by a tablet controller as a navigation tool for the system. Such tablet controller may be wireless and portable to allow for flexible a primary or supplemental navigation tool.

In other exemplary embodiments, multiple cameras may be positioned to capture images from different points of view, and extraction windows may be provided relative to the multiple image captures in a system for selectively displaying portions of native images from different points of view.

Further exemplary embodiments provide real time or near real time tracking of subjects of interest (e.g., identified, selected or pre-tagged players of interest or automatic tracking of a ball in a game). Additional exemplary embodiments also provide virtual directing of operated and automatically tracked subjects of interest for cutting into a full live broadcast, utilizing backend software and tracking technology to provide a virtual viewfinder that operates in manners similar to otherwise human camera operators. Such processes may also use artificial technology for simple tracking, e.g., of a single identified object, or for more complex operations approximating motions utilized by human camera operators, e.g., pan, tilt and zoom of the extraction window in a manner similar to human operators. For those examples using 4K (or the like) capture, camera capture could utilize a specifically designed 4K camera. A camera may also use wider lensing to capture more of the subject, with possible reconstituting or flattening in post production. Also, different lensing can be used specific to different applications.

Such processes may use the above-described multiple cameras and/or multiple extraction windows, or may run with specific regard to one camera and/or one extraction window. In such a way, an artificial intelligence can automatically capture, extract and display material for broadcast, utilizing the extraction window(s) as virtual viewfinders.

Additional exemplary embodiments also provide for virtual 3D extraction, e.g. via s single camera at 4K or 8K with a two window output.

In other exemplary embodiments, an increased image capture frame rates relative to a broadcast frame rate along with or in lieu of an increased image capture resolution, as has been discussed above.

In such embodiments, a first video is captured at a first frame rate, which frame rate is higher than a predetermined broadcast frame rate. A desired portion of the first video is then displayed at a second, lower frame rate, which frame rate is less than and closer to the predetermined broadcast frame rate. The desired portion of the first video is captured by an extraction window that extracts frames across the native captured video. In such a way, the extracted video provides smooth and clear video, without edgy or blurred frames. Such captured first video may be at any frame rate that is above the predetermined broadcast frame rate.

In further exemplary embodiments, the first video is captured at a first frame rate that is in super motion or hyper motion. In traditional video, this equates to approximately 180 (“supermotion”) frames per second or above (“hypermotion” or “ultramotion”) in a progressive frame rate. In exemplary embodiments, hypermotion is recorded in discrete times sufficient to capture a triggered instance of an action of camera subject for playback. In other exemplary embodiments, the present system performs a full time record of a camera in hypermotion, e.g., of sufficient length for replay playback archiving, such as more than fifteen minutes, more than thirty minutes, more than an hour, more than an hour and a half, or more than two hours, among others.

In other exemplary embodiments, raw data from at least one camera is manipulated to adjust the image quality (make it “paintable”) to broadcast specifications. In exemplary embodiments, broadcast “handles” may be integrated into the system to affect the raw data in a manner that is more germane to broadcast color temperatures, hues and gamma variables.

The present disclosure thus advantageously provides systems and methods for selective capture of and presentation of native image portions, for broadcast production or other applications. By providing exemplary embodiments using a selectable extraction window through a GUI, an operator has complete control over portions within the native images that the operator desires for presentation. Also, by providing exemplary embodiments with image capture greater than high definition (e.g., 4K), desired portions of the image selected by an operator may be presented at or relatively near high definition quality (i.e., without relative degradation of image quality). Further, by providing exemplary embodiments with image capture frame rates greater than that of a predetermined broadcast frame rate, extracted video therefrom provides smooth and clear video, without edgy or blurred frames. Finally, various exemplary embodiments utilizing enhanced GUI features, such as automatic tracking of subjects of interests, plural GUIs or extraction windows for one or plural (for different points of view) captured images provide advantageous production flexibilities and advantages.

It will be apparent to those skilled in the art that, while exemplary embodiments have been shown and described, various modifications and variations can be made to the invention disclosed herein without departing from the spirit or scope of the invention. Also, the exemplary implementations described above should be read in a non-limiting fashion, both with regard to construction and methodology. Accordingly, it is to be understood that the various embodiments have been described by way of illustration and not limitation.

What is claimed is:

1. A method for tracking and tagging objects of interest in a broadcast, comprising:
utilizing a camera to track one or more moving objects;
determining interest in said one or more moving objects; and
rendering graphics in a broadcast over or relative to said one or more moving objects, said graphics relating to statistics relative to said one or more moving, previously moving or soon to be moving objects.

2. A method in accordance with claim 1, wherein said graphics relate to a play or to performance of an athlete on a field of play.

3. A method in accordance with claim 1, wherein said tracking is automated and wherein an interface is configured to permit an operator to select one or more objects during a broadcast or to indicate or confirm automatic selection.

4. A method in accordance with claim 3, wherein said selection permits the operator to supply said statistics.

5. A method in accordance with claim 3, wherein said selection presents to an operator or implements one or more pre-selected options.

6. A method in accordance with claim 1, wherein said graphics are provided as a video overlay during or after broadcast.

7. A method in accordance with claim 6, wherein said video is static.

8. A method in accordance with claim 6, wherein said video is dynamic.

9. A method in accordance with claim 6, wherein said video is partially displayed.

10. A method in accordance with claim 6, wherein said video is faded.

11. A method in accordance with claim 6, wherein said video is at least partially phased out.

12. A method in accordance with claim 6, wherein said video imperfectly follows an object during motion.

13. A method in accordance with claim 1, wherein said graphic changes during movement of said object.

14. A method in accordance with claim 13, wherein said graphic rises or fades.

15. A method in accordance with claim 1, wherein at least one of said objects is an athlete on a field of play.

16. A method in accordance with claim 1, wherein tracking and tagging of one or more objects is larger than the displayed portion during broadcast.

17. A method in accordance with claim 16, wherein at least one tracked and tagged object wanders in or out of the displayed broadcast image.

18. A method in accordance with claim 1, wherein an operator determines interest by tagging an object via a terminal linked to an associated tracking system.

19. A method in accordance with claim 1, wherein an operator determined interest by tagging an object via a wireless device in wireless communication with an associated tracking system.

20. A method in accordance with claim 1, wherein said one or more objects includes one or more of players, balls, lines, field marks, non-field marks, coaches, fans, commentators, and non-field events.

21. A method in accordance with claim 1, wherein said tracking is related to prior recognized statistics or importance.

22. A method in accordance with claim 1, wherein said graphic comprises one or more of name identifier, in-game statistics, season statistics, player comments, coach comments and custom notes.

23. A user interface for selective view, capture or replay of plural cameras on an event, comprising:
one or more monitors or touchscreen displays showing one or more tracked objects in a broadcast and configured to indicate selection of said one or more objects by an operator or to indicate automatic selection or confirmation of automatic selection.

24. A user interface in accordance with claim 23, wherein the user interface includes selectable features, including one or more of favorites, auto mode, manual mode, highlight, swap, audio, disk mode, extra mode, animate and selection of statistics.

25. A system for selective view, capture or replay of plural cameras on an event, comprising:
one or more monitors or touchscreen displays showing one or more tracked objects in a broadcast and configured to indicate selection of said one or more objects by an operator;
a camera array configured to provide images for broadcast; and
an optical tracking module configured to track moving objects.

26. A system in accordance with claim 25, wherein said optical tracking module is configured to utilize one or both of image recognition and motion sensitive indication of possible tracking.

27. A system in accordance with claim 25, further comprising at least one rendering computer networked with a user interface associated with said one or more monitors or touchscreen displays.

28. A system in accordance with claim 27, further comprising plural rendering computers networked with said user interface.

29. A system in accordance with claim 25, wherein said broadcast is provided in greater than high definition resolution, with use of one or more selectable extraction window.
